(19) United States
(12) Patent Application Publication
(10) Pub. No.: US 2012/0190754 A1
(43) Pub. Date: Jul. 26, 2012

(54) ANTIMICROBIAL COMPOSITION CONTAINING PARACHLORMETAXYLENOL

(75) Inventors: John D. Bambara, Osterville, MA (US); Edward W. Burmeister, Pace, FL (US); Robert F. Hurley, Centerville, MA (US)

(73) Assignee: Sentinel Products Corp., Osterville, MA (US)

(21) Appl. No.: 13/356,075

(22) Filed: Jan. 23, 2012

Related U.S. Application Data
(63) Continuation of application No. PCT/US2010/042841, filed on Jul. 22, 2010.
(60) Provisional application No. 61/227,537, filed on Jul. 22, 2009.

(51) Int. Cl. A01N 31/08; A47L 13/17; C09D 5/16; C11D 3/48; A01P 1/00

(52) U.S. Cl. 514/737; 510/382; 523/122; 15/104.94

(57) ABSTRACT

A biocidal composition is provided comprising a complex of parachlorometaxylenol and a polycarbocylic acid or a salt thereof. A surfactant can be added to the composition to form a biocidal cleaning composition. The composition can be added to a latex or hot melt polymeric composition to form a biocidal polymeric composition.

### CROSS REFERENCE TO RELATED APPLICATIONS

This application is a continuation of and claims the benefit of International Patent Application PCT/US2010/042841, filed on Jul. 22, 2010, entitled ANTIMICROBIAL COMPOSITION CONTAINING PARACHLORMETAXYLENOL, which application claims priority from U.S. Provisional Patent Application No. 61/227,537, filed on Jul. 22, 2009, entitled ANTIMICROBIAL COMPOSITION CONTAINING PARACHLORMETAXYLENOL, all of which are incorporated herein by reference in its entirety.

### BACKGROUND OF THE INVENTION

This invention relates to antimicrobial compositions containing parachlorometaxylenol and a polycarboxylic acid or a salt thereof that complexes with parachlorometaxylenol to effect anti-microbial activity on a surface.

It is well known that the washing of hard surfaces and skin, especially the hands, with antimicrobial soap, can remove many viruses and bacteria from the washed surfaces. Bacteria found on the skin can be divided into two groups: resident and transient bacteria. Resident bacteria are Gram positive bacteria, which are established as permanent micro-colonies on the surface and outermost layers of the skin and play an important, helpful role in preventing the colonization of other, more harmful bacteria and fungi.

Transient bacteria are bacteria, which are not part of the normal resident flora of the skin, but can be deposited when airborne contaminated material contacts. Transient bacteria are typically divided into two sub-classes: Gram positive and Gram negative. Gram positive bacteria include pathogens such as Staphylococcus aureus, Streptococcus pyogenes and Clostridium botulinum. Gram negative bacteria include pathogens such as Salmonella, Escherichia coli, Klebsiella, Haaemophilus, Pseudomonas aeruginosa, Proteus and Shigella dysenteriae. Gram negative bacteria are generally distinguished from Gram positive by an additional protective cell membrane, which generally results in the Gram negative bacterial being less susceptible to topical antibacterial compositions.

Antimicrobial cleansing products have been marketed in a variety of forms for some time. These traditional rinse-off antimicrobial products have been formulated to provide bacteria removal during washing. The technology for biocide compositions is well developed and commercialized. Available products include disinfectant sprays, soaps and wipes, anti-mildew coating and paints, anti-bacterial food handling supplies and plastics containing biocides. The antimicrobial soaps have also been shown to provide a residual effectiveness against Gram positive bacteria, but limited residual effectiveness against Gram negative bacteria. By residual effectiveness, it is meant that bacteria growth on a surface is controlled for some period of time following the washing/rinsing process.

A major shortcoming of many of the commercial products is their short time duration of effectiveness. Durable biocides have been developed based on blends of phenol with polycarboxylic acids and amines. When blended properly, these ingredients form complexes that inhibit their mobility and the effective time of duration. Unfortunately, these compositions have problems of the toxicity of the phenol and the inability to remain stable in high temperature applications. The boiling point of phenol renders it unusable in conventional plastic processing.

Accordingly, it would be desirable to provide biocide compositions which are effective over extended time periods and which are stable under normal plastic forming conditions.

### SUMMARY OF THE INVENTION

The present invention provides an antimicrobial composition that can be used as a cleansing composition or a coating composition. The antimicrobial composition comprises parachlorometaxylenol (4-chloro-3,5-dimethyl phenol) (PCMX), a polycarboxylic acid or a salt thereof that forms a complex with PCMX and a solvent preferably with good humectant properties. When used as a cleaning composition, an anionic or nonionic surfactant, which functions as a soap, is added to the PCMX complex. In one aspect of this invention, the PCMX complex is added with a latex composition such as acrylic latex in order to permanently adhere the PCMX complex to a substrate. In another aspect of this invention, the PCMX complex can be absorbed into a hydrophilic foam composition such as a melamine foam. The PCMX complex containing foam can be utilized as an applicator to apply the PCMX complex to a desired substrate. In another aspect of this invention, the PCMX complex together with a latex composition can be added to a cloth substrate to render the cloth substrate antimicrobial, It has been found that the PCMX complex retains its antimicrobial activity on a substrate far longer than PCMX alone.

### BRIEF DESCRIPTION OF THE DRAWINGS

FIG. 1 is a side view of an applicator useful in the present invention.

FIG. 2 is a bottom view of the applicator of FIG. 1.

FIG. 3 is a top view of a foam structure containing an antimicrobial and which can be connected to the applicator of FIGS. 1 and 2.

FIG. 4 is a side view of the foam structure of FIG. 3.

FIG. 5 is a process diagram for producing a foam containing the PCMX polycarboxylic acid or salt thereof complex.

### DESCRIPTION OF SPECIFIC EMBODIMENTS

In accordance with this invention, PCMX is complexed with a polycarboxylic acid or a salt thereof, such as a sodium salt or a potassium salt. Formation of the complex promotes the retention of PCMX on or in a substrate. Representative suitable polycarboxylic acids include tartaric acid, succinic acid, maleic acid, malonic acid, actinic acid, citric acid, or the like.

It is preferred to utilize succinic acid, citric acid or tartaric acid with tartaric acid being the most preferred.

In order to form the complex of PCMX and carboxylic acid or salt thereof of this invention, the weight ratio of polycarboxylic acid or salt thereof to PCMX is between about 1:8 and about 8:1 preferably between about 1:1 and 3:1.

The PCMX and polycarboxylic acid or salt thereof can be complexed together by mixing the PCMX and polycarboxylic acid in a solvent or carrier to form a composition to which optional ingredients can be added. Useful solvents or carriers which promote mixing of the PCMX and polycarboxylic acid include glycerin, propylene glycol, water, methanol, ethanol, isopropanol, pine oil, plasticizers such as dioctyl phthalate or the like or mixtures thereof. The antimicrobial effect of the PCMX complex of this invention on a substrate lasts for months or longer as compared to hours for PCMX alone.

The surfactants are in the system for one of three reasons. First, they allow for incompatible materials to be blended, by acting as emulsifying agents. Second, they allow for cleaning by chemical mechanical means or by reduction of the surface tension of the water or carrier. Third, they allow for “wetting out” of the surface that is being sprayed. The surfactants will fall into three categories-nonionic, anionic and cationic, having no charge, a negative charge or a positive charge, respectively. Suitable useful surfactants that promote mixing of ingredients including the complex of PCMX-polycarboxylic acid or salt thereof include alkyldiphenyloxide disulfonate anionic surfactant (Dowfax 3B2 surfactant available from Dow Chemical Corp., Midland, Mich.), or the like. The preferred surfactant is alkyldiphenyloxide disulfonate anionic surfactant Suitable amounts of the surfactant that promotes mixing is between about 0.25% and about 15% by weight, preferably between about 0.5% and about 5% by weight based on the weight of the mixture.

A second useful optional ingredient is a surfactant, which functions as a soap. Representatives of such surfactants include polyether polyol anionic surfactant (Tergitol L-61 surfactant available from Dow Chemical Corp., Midland, Mich.), polyether polyol nonionic surfactant (Tergitol L-64 surfactant available from Dow Chemical Corp., Midland, Mich.), octylphenol ethoxylate nonionic surfactant (Triton X-100 surfactant available from Dow Chemical Corp. alkylphenol ethoxylate free surfactant (Carbowet 13-40 surfactant available from Air Products, Allentown, Pa.), or the like or mixtures thereof. Suitable amounts of this surfactant is between about 0.25% and about 15% by weight, preferably between about 1% and about 5% by weight based on the weight of the mixture.

The surfactants containing PCMX-polycarboxylic acid composition are useful for cleaning a surface and for depositing the PCMX complex biocide on or in a surface. The complex can be applied by any conventional means including as a wipe, a spray, a sanitizer, an aerosol or deposited within a foam, which is hydrophilic. The liquid PCMX complex also can be applied to a surface with a roller. This can be done by dipping the roller or by a cartridge system to a roller, which opens the cartridge when the cartridge is loaded into the roller and then the liquid is dispersed to the roller head through an internal means. In addition, the formulation can be used in conventional roller appliers, such as the Wagner Power Roller. Examples of the roller head include those made from fiber, urethane foam or melamine foam. The PCMX complex should not be added to a polymeric material containing peroxide since the peroxide and PCMX undesirably react to form chlorine.

A third useful optional ingredient comprises a polymeric based latex, which is capable of forming a film on or in a substrate when dried. This film serves the useful function of retaining the PCMX complex on a substrate thereby extending the useful active time for the biocide. Representative useful latexes include acrylic synthetic latex with an anionic emulsifier (Hycar 26345 available from Lubrizol Advanced Materials, Cleveland, Ohio), carboxylated acrylic polymer synthetic latex with anionic emulsifier (Hycar 26084 available from Lubrizol Advanced Materials, Cleveland, Ohio) acrylonitrile butadiene latex, polyamide latex, polybutadiene latex, ethylene vinyl acetate latex, polybutylene latex, polypropylene latex, acrylic latex, alkyd latex, ethylene vinyl acetate latex, natural rubber, neoprene latex, polychloroprene latex, polyester latex, polyester emulsion latex, polyisoprene latex, polypropylene emulsion latex, polyurethane latex, polyvinyl acetate latex, polyvinyl alcohol latex, polyvinyl butyral latex, polyvinyl chloride latex, polyvinylidene chloride latex, silicone emulsion, styrene isoprene latex or styrene acronitrile latex, styrene acrylic latex, styrene butadiene rubber latex, vinyl acetate latex, vinyl acetate-ethylene latex, vinyl alcohol latex, wax emulsion latex or mixtures thereof. The latex containing PCMX-polycarboxylic acid or salt thereof composition can be deposited on a substrate such as a solid surface, cloth or a foam and then dried to provide the substrate with biocide for extended time periods. Suitable amounts, of the PCMX polycarboxylic acid to above polymer, on a dry basis, are between about 0.5% and about 10% by weight, preferably between about 1% and about 5% by weight based on the weight of the mixture.

In a fourth useful option, the PCMX polycarboxylic acid or salt thereof can be incorporated into a hot melt polymeric composition such as polyethylene, ethylene vinyl acetate, polyester, polyamide, polyurethane, polyvinyl chloride, polystyrene, silicone based polymer systems, polyphenyl oxide, polyolefin or mixtures thereof. Suitable amounts, of the PCMX polycarboxylic acid to above polymer, on a dry basis, of the hot melt composition is between about 0.5% and about 10% by weight, preferably between about 1% and about 5% by weight based on the weight of the mixture. The PCMX polycarboxylic acid or salt thereof can be added to a wide variety of substrates to inhibit the growth of bacteria or mold or the like biologicals.

Representative suitable substrates for use in the present invention includes polymeric films, paints, protective coatings, nonwovens, fabrics and textiles, films, foils, paper, Tyvek, wood, metal, plastic, glass, leather, carpet, drywall, masonry, synthetic flooring, sponges, fabrics used for medical apparel-durable and disposable, fabrics used for covering material used for medical furniture, materials utilized in the packaging of medical devices and wraps for such devices, protective gloves, hand sanitizer composition, packaging for food, or in construction materials such as roofing, gutters, siding, containers such as plastic bags, carpeting, lumber, concrete blocks, drywall or the like.

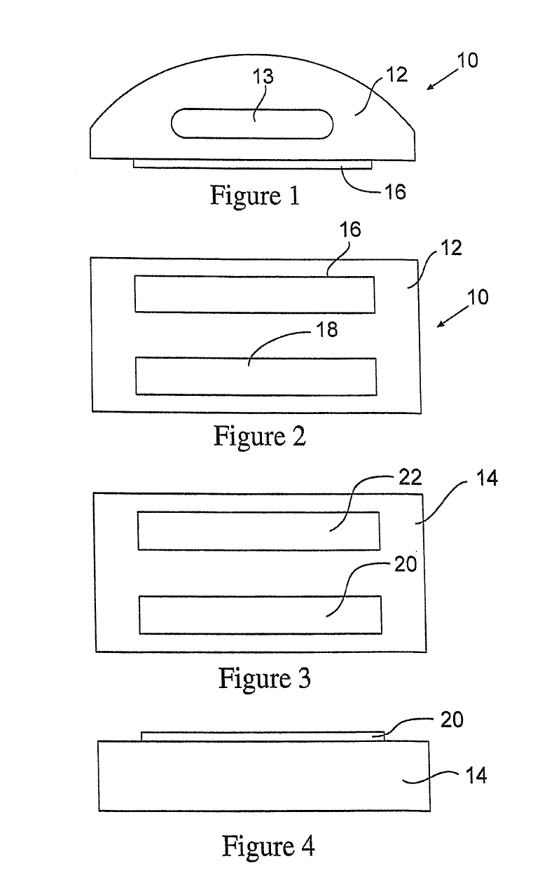

Referring to FIGS. 1 and 2, an applicator 10 of this invention is shown. The applicator comprises a handle 12, an open having a finger grasp 13. Two strips of Velcro 16 and 18 are adhered to the handle 12.

Referring to FIGS. 3 and 4, a hydrophilic flexible foam 14 such as a melamine foam has adhered thereto two Velcro strips 20 and 22. The flexible foam 14 contains the PCMX polycarboxylic acid or salt thereof complex. The handle 12 and foam 14 are joined together by Velcro strips 16, 18, 20 and 22. A single Velcro strip or more than two Velcro strips can be provided on each handle 12 and each foam 14 if desired. By utilizing this structure, the handle can be reused many times and the foam can be replaced periodically. Other conventional means can be used to join the handle and the foam such as clips. The Velcro strips comprise plastic fingers, which intertwine to form a connection between the handle 12 and the foam 14.

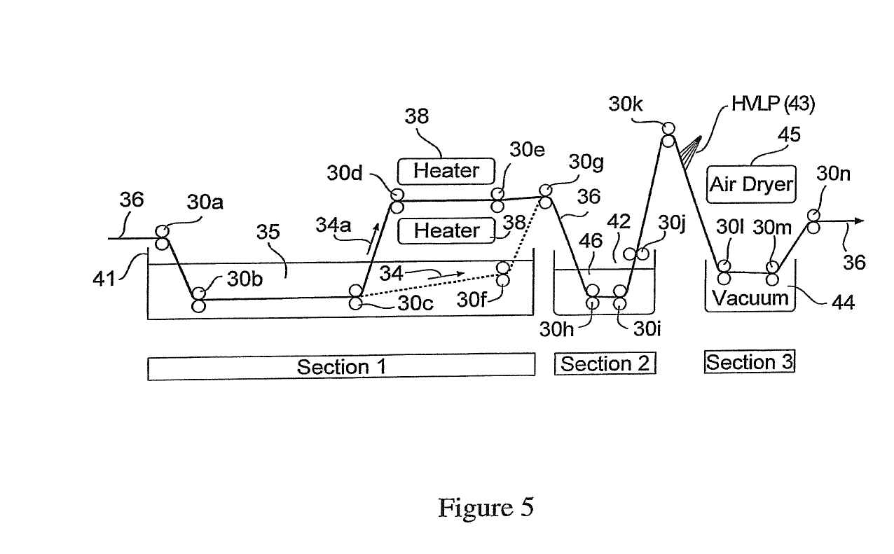

Referring to FIG. 5, all the driven rollers 30a, 30b, 30c, 30d, 30e, 30f, 30g, 30h, 30i, 30j, 30k, 30l, 30m and 30n function to either transfer a foam or squeeze the foam. When they squeeze the foam, the function is either to compress the foam, while the foam is immersed in liquid, to allow the foam to soak up the liquid or to compress the foam to drive out the liquid.

In section 1, lines 34 and 34a show two alternative paths for the web 36 such as a foam. Path 34 is used when there is no acrylic emulsion and path 34a is used when there is acrylic emulsion in the liquid 35. Since the foam will tend to float, the system guides and forces the foam 36 down into the liquid. This system can be formed from sheet metal or plastic or bats so long as the foam sheets can slide along. This type of system is used in any area where there is a dip tank. In the system shown, the foam 36 which passes in either path 34 or 34a is fed into the initial drive rollers 30a, 30b and 30c, and are not touched by human hands until it has been through the entire process. All of the driven rollers have an adjustable gap so that the system can process more than one thickness of foam. The tanks 41, 42 and 44 can be constructed from stainless steel or other corrosion resistant material.

Referring to section 1, the tank 41 can contain one of the following:
1) PCMX complex mix only (Example 1)
2) PCMX complex mix with surfactant
3) PCMX complex mix and acrylic emulsion (Example 2)
4) PCMX complex mix, acrylic emulsion and surfactant or soap for cleaning the foam sheet fed into the initial driven nip rollers 30a. (Example 3)

The sheet 36 in path 34 or 34a is directed to the driven nip rollers 30b, 30c and 30f, which are positioned under the liquid 35 containing the PCMX complex in container 41. The foam 36 is directed to the set of nip rollers 30g which are above the liquid level. These rollers 30g are capable of having a known gap set so that the amount of liquid left in the foam can be controlled. The last set of rollers 30g in section 1 applies the minimal amount of pressure required to transfer the sheet 36 forward to the next rollers 30g as well as rollers 30h and 30i in section 2.

The heaters 38 can be Infrared, Quartz lamps, Electric, Gas fired, microwave or the like. The temperature is set so that the sheet is heated to a minimum of 180° F., with the optimum range being about 190 to 210° F. Drive rollers 30d and 30e feed the foam 36 through the heater area between heaters 38 and another set of feed rollers 30g extract the foam 36 from the heater area. The driven rollers 30g at the end of the heater system extract the sheet from the heater area and transfer the foam 36 to Section 2.

Referring to section 2, the objective of this section is to immerse the sheet 34 in water and remove excess propylene glycol in the sheet. The sheet 36 is fed into the driven rollers 30h. The sheet 36 is forced down into the water bath 39 and to the driven feed rollers 30h and 30i and 30j which are under water 46. The driven feed rollers 30h and 30i function as nip rollers to drive out the air and propylene glycol and water, which are in the sheet, and water is drawn into the sheet when it exits the nip rollers 32i. The sheet 36 is guided to a set of driven nip rollers 30i, which are above the water level in the tank 42. Their function is to squeeze out as much liquid as possible, so that the sheet is as dry as possible and the propylene glycol is not longer in the sheet. The nip rollers 30k then direct the sheet 36 to Section 3.

Referring to Section 3, an optional high volume, low pressure (HVLP) spray system can be utilized to apply other compounds such as surfactants. Alternatively a dip tank can be utilized. The object of section 3 is to drive off any excess water in the sheet using forced air. In section 3, a conveyor or additional feed rollers 30l and 30m are provided to keep the sheet 36 moving through the dryer section 3 at a constant rate. A vacuum system 44 can be provided under the travel path of the sheet 36. By having the heated air pulled through the sheet 36, the maximum amount of water is removed from the sheet 36. The set of driven rollers 30m, at the rear of the vacuum system 44, removes the sheet 36 from the dyer unit 45. Any conventional heating system can be provided.

The following examples illustrate the present invention and are not intended to limit the same. The amounts of the ingredients in the examples are parts by weight.

### Example 1

### System #1 with “Soap” for Cleaning

| | | |
|---|---|---|
| Main Mix | Propylene glycol | 60% |
| | PCMX | 3% |
| | Water | 35.5% |
| | Tartartic Acid | 1.5% |

The above is premixed with Dowfax 3B2, an anionic surfactant from Dow Chemical Corp, and is diluted with water from its 45% active state to a 10% active state. 3 volume units of the 10% active Dowfax 3B2 is added directly 97 volume units of the above main mix. This is done while the main mix is under agitation or being stirred.

To the above mix, one of the following surfactants is added to create the soap cleaning portion of the system. The amount can range from 2% to 25%, depending upon the amount of cleaning required.
Tergitol L-61
Tergitol L-64
Triton X-100
Carbowet 13-40

### Example 2

### System #1 with Acrylic Latex

| | | |
|---|---|---|
| Main Mix | Propylene glycol | 60% |
| | PCMX | 3% |
| | Water | 35.5% |
| | Tartartic Acid | 1.5% |

The above is premixed. Dowfax 3B2, is diluted with water from its 45% active state to a 10% active state. 3 volume units of the 10% active Dowfax 3B2 is added directly to 97 volume units of the above main mix. This is done while the main mix is under agitation or being stirred.

The Dowfax 3B2 10% active mixture is added to the following to each of the acrylic synthetic emulsions at a ratio of 95 volume units of the emulsion and 5 volume units of the Dowfax 3B2 10% active mixture, while the emulsion is under agitation.
Hycar 26084 manufactured by Lubrizol Advanced Materials
Hycar 26171 manufactured by Lubrizol Advanced Materials
Hycar 26345 manufactured by Lubrizol Advanced Materials
The acrylic emulsion blend is added to the “main mix” while the main mix is under agitation. The level of addition ranges from 2% to 50% on a wet basis, depending upon the amount of adhesion and film forming properties required in the finished product.

This can be used for a sponge to keep bacterial and mold growth from occurring or on a fabric or cloth to keep bacterial growth from occurring (i.e., hospital gowns, scrubs or apparel).

### Example 3

### System #1 with Acrylic and Soap (for Cleaning)

This is a two step operation, such as a system to make a sponge or cloth, which would have the main mix or antimicrobial retained in place by the acrylic, so the sponge is resistant to bacterial and mold growth, and the added soap functions when the substrate is exposed to water, and used by the end consumer.

A) The straight mix with acrylic is applied to the substrate and the coated substrate is dried, so that the acrylic has formed an adequate film to hold the PCMX-polycarboxylic acid complex in place.

### Example 4

This Example illustrates the making of a liquid product of this invention. Dowfax 3B2 (45% active) is agitated. While under agitation PCMX is added to the Dowfax 3B2. The weight range for addition of PCMX is from 5% to 100% of the weight of the Dowfax 3B2, preferably 40%-80% of the weight of the Dowfax 3B2. The resultant mixture is agitated and heated until the PCMX is dissolved. Heating can be conducted at a temperature between about 100° F. and about 220° F., preferably between about 100° F. and about 160° F. When the PCMX is completely dispersed, tartaric acid is slowly added to the Dowfax 3B2/PCMX, under agitation. The amount of tartaric acid added to the system is one half the weight of the PCMX that was mixed into the Dowfax 3B2. The tartaric acid is added slowly, under agitation, and allowed to mix until all the material is dissolved or in solution.

After the above mixture is dissolved, the appropriate solvent or carrier is added to the mix. The solvent or carrier can be materials such as propylene glycol, pine oil, ethanol, methanol, water or mixtures thereof. The mixture of the solvent or carrier into the afore-mentioned is agitated and heated in the temperature range set forth above.

### Example 5

This example provides a thermoplastic polymer or hot melt system containing the PCMX complex: In this system, the solvent or carrier is a solid at room temperature. The most used system is a wax, with a melt point in the range of 120° F.-280° F., preferably between about 140° F. and about 190° F. The wax can be a natural wax, a paraffin wax or a petroleum based wax. A typical wax would be IGI 1303A or IGI 1297A available from International Group Inc., Titusville, Pa. A second solvent or carrier comprises a tackifing rosin or resin, with a carbon chain length of C5 or C9. Typical tackifiers would be Slyvares TR-7125 and Slyvares TR-2040 available from Arizona Chemical, Savannah, Ga. The choice of wax or tackifiers is made so that the molten viscosity is low enough so that the PCMX and tartaric acid can be blended with the wax or tackifiers, under agitation. Typical viscosities are within 100-30,000 centipoises at 300 F. The particular viscosity is chosen based upon the desired melt viscosity of the end product to which the mixture is added.

The wax or tackifing agent is heated to above its melt point, to the desired viscosity and agitated. PCMX is added to the molten wax or tackifiers slowly, while under agitation. The amount of addition typically ranges from about 10% to about 100% of the weight of the wax and tackifing agent, depending upon the desired concentration in the end product. The molten solution is allowed to mix until all the PCMX is thoroughly dispersed or dissolved. Tartaric acid is added slowly while the system is under agitation, and the system is allowed to mix until the tartaric acid is thoroughly mixed or dispersed. The amount of tartaric acid is between about 10% and about 100% by weight of the mix and tackifying agent and is such that the ratio of PCMX to tartaric acid is about 2:1.

The mixture is cooled and used to add the PCMX polycarboxylic acid or salt in a hot melt polymeric composition such as polyethylene, ethylene vinyl acetate, polyester, polyamide, polyurethane, polyvinyl chloride, polystyrene, silicone based polymer systems, polyphenyl oxide, polyolefin or mixtures thereof, at a rate which gives the desired antimicrobial properties to the finished adhesive or coating system.

1. A complex of parachlorometaxylenol and a polycarboxylic acid or a salt thereof.

2. The complex of claim 1 wherein the acid is tartaric acid.

3. The complex of claim 1 wherein the acid is succinic acid.

4. The complex of claim 1 wherein the acid is citric acid.

5. A composition comprising the complex of claim 1, which includes a surfactant which promotes mixing of said complex with an ingredient added to said complex and said surfactant.

6. The composition of claim 5 wherein said surfactant is alkyldiphenyloxide disulfonate anionic surfactant.

7. The process of rendering a substrate antimicrobial which comprises applying a complex of parachlorometaxylenol and a polycarboxylic acid or a salt thereof to said substrate.

8. The process of claim 7 wherein said complex contains an anionic surfactant, a nonionic surfactant, a cationic surfactant or mixtures thereof.

9. The process of claim 7 wherein said complex contains a polymeric latex.

10. The process of claim 7 wherein said substrate is a solid surface.

11. The process of claim 7 wherein said substrate is a cloth.

12. The process of claim 7 wherein said substrate is a flexible polymeric foam.

13. The process of claim 12 wherein the foam is melamine foam.

14. An applicator comprising a handle joined to a foam containing the complex of claim 1.

15. The applicator of claim 14 wherein said handle and said foam are joined together by at least one strip having curved plastic fingers, said at least one strip being positioned on each of said handle and said foam.

16. A composition comprising the complex of claim 6 which includes a surfactant which promotes mixing of said complex with an ingredient added to said complex and said surfactant.

17. A composition comprising the complex of claim 7 which includes a surfactant which promotes mixing of said complex with an ingredient added to said complex and said surfactant.

18. A composition comprising the complex of claim 8 which includes a surfactant which promotes mixing of said complex with an ingredient added to said complex and said surfactant.

19. The process of claim 8 wherein said substrate is a solid surface.

20. The process of claim 9 wherein said substrate is a solid surface.
